(19) United States
(12) Patent Application Publication
(10) Pub. No.: US 2025/0364882 A1
(43) Pub. Date: Nov. 27, 2025

(54) TRANSLATORY ACTUATION UNIT HAVING A DIELECTRIC ELASTOMER ACTUATOR

(71) Applicants: UNIVERSITÄT DES SAARLANDES, Saarbrucken (DE); ZEMA ZENTRUM FÜR MECHATRONIK UND AUTOMATISIERUNGSTECHNIK GEMEINNÜTZIGE GMB, Saarbrucken (DE)

(72) Inventors: Daniel BRUCH, Saarbrucken (DE); Hendrik SCHAFER, Saarbrucken (DE); Paul MOTZKI, Saarbrucken (DE); Stefan SEELECKE, Saarbrucken (DE)

(21) Appl. No.: 18/872,879

(22) PCT Filed: Jun. 6, 2023
(86) PCT No.: PCT/EP2023/065035

§ 371 Date: Dec. 9, 2024

(30) Foreign Application Priority Data
Jun. 7, 2022 (DE) 10 2022 114 243.4

(51) Int. Cl. H02K 41/02; H02K 7/116

(52) U.S. Cl. CPC H02K 41/02; H02K 7/116

(57) ABSTRACT

The invention relates to a translatory actuator (1, 100), comprising:
a dielectric elastomer actuator (DEA) (3, 103) configured to be altered from a non-activated state into an activated state by applying an electrical voltage so that a change in length occurs in at least one displacement direction (A) between two terminals;
an actuating element (5, 105) for providing an actuating stroke and/or an actuating force in a translatory actuating direction (S);
a linear gear (4, 104) connecting the DEA (3, 103) to the actuating element (5, 105) with a gear reduction or a gear ratio;
a spring device that is mechanically coupled to the DEA (3, 103) and/or to the linear gear and/or comprises the linear gear (4, 104), the spring device (6, 106) having an at least partially negative spring constant characteristic, so that when the DEA is activated, its displacement in the displacement direction (A) is supported with a greater force or its displacement is counteracted by a smaller force than in the non-activated state.

### TECHNICAL FIELD

The invention relates to actuators for electromechanical actuation, in particular actuators with dielectric elastomer actuators (DEA).

### TECHNICAL BACKGROUND

A dielectric elastomer actuator is constructed with a flat, highly elastic dielectric polymer layer sandwiched between two flexible and conductive electrodes. The material of the polymer layer may be or contain a natural or synthetic rubber, silicone or acrylic. The electrodes are usually constructed by carbon compositions and/or metal structures.

When a high electrical voltage is applied to the electrodes, an electrical field is formed by the dielectric polymer, which exerts an electrostatic force (Maxwell force) between the electrodes that compresses the polymer layer. This reduces the thickness of the polymer layer and causes it to expand in the surface direction due to material displacement. This effect can be used for electromechanical actuators to effect a translational displacement or an actuating force.

Due to their low weight, the use of DEAs in actuators is suitable for robotic applications, servo drives, and valve control systems, among others. In addition, DEA actuators can hold various actuating positions with very little energy loss in static operation. DEAs can also be operated dynamically at up to several kHz to drive pumps or sounders, for example.

One possible approach for using a DEA in an electromechanical actuator is to couple the DEA with a linear gear in order to adapt the force-stroke characteristic of the DEA with a configurable transmission or reduction ratio through the design of the linear gear.

DEA actuators of this kind are usually designed for a specific load situation. Using such an electromechanical actuator for applications with different load situations requires either a constructive design of the actuator for the most demanding application, so that it is over-dimensioned for the less demanding applications, or a separate design of the actuator for each application, which results in a large number of different actuator types, thereby increasing costs and manufacturing efforts in the mass production. In addition, the displacements are usually too small for many applications in the case of linear gears with reduction ratios.

The object of the present invention is to provide an improved translatory actuator with a DEA that can be used and adapted for various applications with different load requirements. Furthermore, the object is to provide an improved translatory actuator with a DEA that also has an adequate actuating distance in a reduction gear.

### SUMMARY OF THE INVENTION

This object is achieved by the translatory actuator according to claim 1 and a method for adapting the translatory actuator to different load requirements according to the further independent claim.

Further embodiments are indicated in the dependent claims.

According to a first aspect, a translatory actuator is provided, comprising:
a dielectric elastomer actuator (DEA) configured to be switched from a non-activated state into an activated state by applying an electrical voltage so that a change in length occurs in at least one displacement direction between two terminals;
an actuating element for providing an actuating stroke and/or an actuating force in a translatory actuating direction;
a linear gear connecting the DEA to the actuating element with a gear reduction or a gear transmission;
a spring device that is mechanically coupled to the DEA and/or to the linear gear and/or comprises the linear gear, the spring device having an at least partially negative spring constant characteristic, so that when the DEA is activated, its displacement in the displacement direction is supported with a greater force or its displacement is counteracted by a smaller force than in the non-activated state.

In particular, wherein a first terminal of the DEA can be fixed in position with respect to the actuator, for example on the housing of the actuator.

Such an actuator makes it possible to achieve a high actuating force with a comparatively large actuating stroke for a DEA.

Furthermore, the linear gear can be configured bidirectional and have a first coupling point and a second coupling point, wherein the first coupling point can be detachably connected to a second connection of the DEA and the second coupling point can be detachably connected to the actuating element, and wherein the second coupling point can be detachably connected to a second connection of the DEA and the first coupling point can be detachably connected to the actuating element.

One idea of the above translatory actuator is to couple the DEA to a bidirectionally usable linear gear. In this case, the linear gear can be provided in the actuator in a releasable manner. The linear gear can be mechanically connected to both the DEA and the actuating element by means of a first coupling point and a second coupling point, which are preferably movable along a longitudinal direction with a transmission ratio or reduction ratio and are coupled to one another.

The additional detachability of the coupling points allows, depending on the installation position, both an increase and a decrease to be achieved with the same components, in particular with the same linear gear. In particular, the extension of the stroke achievable by the DEA by the negative spring constant characteristic of the spring device makes it possible to realize a decrease in which the displacement of the actuating element is less than the displacement of the DEA but is nevertheless still sufficient for downstream applications.

The detachability can be achieved in a manner known per se by means of a form-fitting and/or force-locking connection, such as a screw connection, a plug connection, a latching connection and the like.

In order to sufficiently extend the required adjustment path of the DEA, in particular in the case of a gear reduction, so that a significant adjustment path of the actuating element can be provided despite the gear reduction, the DEA is prestressed in the lengthening direction, i.e. in the direction of an elongation of the DEA, by means of a spring device, the spring device having a negative spring constant characteristic in the working range of the translatory actuating element. The negative spring constant characteristic defines a spring force that is dependent on the displacement and acts on the DEA and, with increasing displacement (activation) of the DEA, increasingly supports the displacement or counteracts the displacement to a lesser extent than in the non-displaced, i.e. non-activated state. The spring device thus represents a negative preloading mechanism for the mechanics of the actuator.

While an increase in the displacement of the actuator is also easily achieved by a (lossless) gear mechanism, the spring device with negative spring constant characteristic simultaneously achieves an increased yield of mechanical work or cyclically repeatable mechanical energy from the DEA. This improves the efficiency and energy yield of the DEA (in static operation). An actuator that is optimised in terms of efficiency and energy has precisely one actuating force/stroke characteristic that can be adapted to the load using a (downstream and preferably lossless) gear mechanism (while maintaining the efficiency and performance optimization).

The spring device may comprise a buckled beam mechanism that is mechanically coupled to the DEA such that the displacements in both the non-activated state and the activated state of the DEA lie in a range of negative spring constant characteristics in which a spring constant of the spring device is negative with respect to a displacement of the DEA. The buckled beam mechanism, for example, corresponds to a snap-action spring arrangement that can assume two bistable states. In the transition region between the bistable states, after the transition of a tipping point, there is a range in which the spring characteristic has a negative spring constant characteristic and thus has a decreasing spring force with increasing displacement. The range of the negative spring constant characteristic is configured such that it encompasses the position of the DEA in the non-activated state and the position in the activated state at maximum displacement of the DEA. That is, the design is such that the working range in which the spring device has a negative spring constant characteristic encompasses the adjustment range of the DEA.

It may be provided that the linear gear has a linkage gear in which at least three rod elements are pivotally connected to one another at coupling points so that, when the actuator moves, all the angles between the rod elements change, two of the coupling points being mounted in particular in the direction of displacement so as to be translationally displaceable. The rod elements can be pivotally mounted at the coupling points and at the attachment point, so that no torque can be absorbed. As a result, the rod elements form two triangles with the displacement axis of the coupling points, the interior angles of which change when one of the coupling points is displaced (which also displaces the other coupling point).

Alternatively or in addition, the linear gear may comprise a first linkage arrangement having first rod elements arranged in a flat quadrilateral, connected to each other at corners of the quadrilateral and pivotable in the surface direction of the quadrilateral, wherein a second linkage arrangement is provided with two second rod elements, which form a further flat quadrilateral of different size with two of the first rod elements of the first linkage arrangement, forms a further flat quadrilateral of different size, which has corners at which the rod elements can be pivoted against one another, the rod elements being dimensioned such that three corners of the linkage arrangements lie in a row and form an attachment point and the first and second coupling points.

The linear gear can thus be formed by means of two linkage arrangements with pivotable corner joints arranged in quadrangles, the movement of each of which is mechanically coupled to two adjacent rod elements. The rod elements have different dimensions. If one corner of the linkage arrangements is fixed in place, for example on a housing of the translatory actuator, then a further corner lying in the longitudinal direction can represent a first coupling point and a further corner can represent a second coupling point. The first coupling point can be connected to the DEA and the second coupling point to the actuating element and vice versa.

Furthermore, the attachment point can be arranged on a housing of the actuator in a detachable manner so that a reverse installation of the linear gear is possible.

It may be provided that one (or more) spring element(s) with predetermined spring constants (positive spring constant characteristic) is (are) arranged on one or more of the rod elements between two rod elements coupled to one another pivotally via a corner, so that a moment in the direction of a decreasing angle the coupling points with respect to the direction of displacement, the angular range of possible angles at the coupling points for a displacement of the DEA in the non-activated state and in the activated state with maximum drive preferably being above a limit angle, from which the negative spring constant characteristic is present. The critical angle is determined by the mechanical dimensions of the rod elements, the spring constant of the one or more spring elements and the points of application of the one or more spring elements.

The connection of the linear gear mechanism with a spring element with a positive spring constant characteristic enables the realization of a transmission and/or reduction between the DEA and the actuating element as well as a spring effect with a negative spring constant characteristic to support the stroke of the DEA in a particularly compact and simple way.

As spring elements, tension springs, pressure springs and/or torsion springs can be provided at the corners between the rod elements or at the coupling points with linear or non-linear characteristics, such as leaf springs, spiral springs, as well as active spring elements with adjustable positive spring constant (e.g. shape memory spring, dielectric elastomer, etc.).

Alternatively or additionally, a (further) spring element with a predetermined spring constant can be held stationary at one end and arranged at a further end on one of the rod elements, so that a torque is applied to the respective rod element in the direction of an increasing angle between the direction of the acting spring force and the longitudinal direction of a section of the relevant rod element to the corresponding coupling point, the angular range of possible angles between the rod elements and the direction of the spring force for a displacement of the DEA in the non-activated state and in the activated state with maximum drive being below a critical angle, below which the negative spring constant characteristic is present.

Furthermore, the ends of the at least one spring element can be detachably attached to a corresponding attachment point of the respective rod element(s), wherein in particular a plurality of attachment points are arranged on the respective rod elements in order to detachably attach the ends of the spring element at different distances from a pivot point of the respective rod element. The spring element can be detachably attached by means of a form-fitting and/or force-fitting connection. This allows for variable adjustment of the negative spring constant characteristic.

### BRIEF DESCRIPTION OF THE DRAWINGS

The following sections describe the embodiments in more detail using the attached drawings. In which:

FIG. 1 shows a schematic representation of a translational actuator;

FIGS. 2a and 2b show a comparison of a DEA with a PBS spring device in the activated and non-activated state and a DEA with an NBS spring device in the activated and non-activated state, as well as a representation of the resulting characteristic curves;

FIG. 3 shows a representation of a buckled beam mechanism with a tensioned leaf spring and a corresponding spring characteristic;

FIGS. 4a and 4b show functional representations of linkage transmissions as examples of linear transmissions that provide a gear transmission and a gear reduction depending on which coupling point the DEA acts on;

FIG. 5 shows a representation of a design of the linear gear as a component manufactured in one piece;

FIG. 6 shows a perspective view of an exemplary design of a translatory actuator;

FIGS. 7a to 7c show various configurations of the translatory actuator of FIG. 6; and

FIG. 8 shows an arrangement for realising the spring device with the negative spring constant characteristic in the linear drive of FIG. 5.

### DESCRIPTION OF EMBODIMENTS

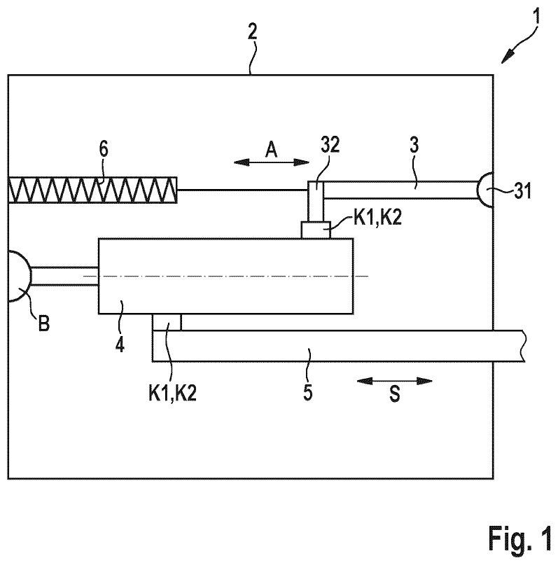

FIG. 1 shows a schematic representation of a translatory actuator 1 that can be configured in terms of displacement and actuating force. The translatory actuator 1 comprises a housing 2.

A dielectric elastomer actuator (DEA) 3 is provided in the housing 2, which is firmly attached to the housing 2 by means of a first connection 31 and is arranged on a linear gear 4 by means of a second connection 32. The first and second connections 31, 32 are arranged in a displacement direction A with respect to one another. Alternatively, a floating mounting of the DEA (mounted on both sides with springs) can also be provided.

The DEA 3 can be formed in a manner known per se with a layer of an elastic dielectric material, such as an elastomer, such as for example a silicone film, for example with a thickness between 20 μm and 200 μm, on the surface sides of which electrodes are applied, for example by printing with a conductive carbon coating, which can be contacted electrically via suitable electrodes. The DEA 3 can be constructed in several layers to increase the actuating force when an electrical voltage is applied.

In an activated state, an electrical voltage of several 100 Volts is applied to the electrodes of the DEA 3. An electrical voltage at the electrodes of the DEA 3 causes the formation of an electrical field between the electrodes through the dielectric material and causes an electrostatic attractive force between the electrodes, which compresses the elastic dielectric material. Due to the incompressibility of elastic materials, a change in length of the dielectric material in one or both surface directions is caused. Preferably, the displacement in one surface direction is effected as the displacement direction A by limiting the possibility of expansion in a surface direction running transversely to this.

The linear gear 4 is preferably designed as a bidirectional gear and has a transmission ratio or reduction ratio between a first coupling point K1 and a second coupling point K2 of the linear gear 4 which is not equal to 1. The bidirectional transmission thus makes it possible to form a translatory actuator with a high actuating distance and low actuating force or a low actuating distance and high actuating force, depending on which of the coupling points K1, K2 of the linear transmission 4 the second end of the DEA 3 is coupled.

The other coupling point K2, K1 of the linear gear 4 is mechanically coupled or directly connected to a actuating element 5 for providing a translatory stroke/actuating path or an actuating force in an actuating direction S. The actuating element 5 is guided so as to be movable in translatory fashion in the actuating direction S, wherein preferably the direction of displacement A of the DEA 3 extends parallel to the actuating direction S of the guidance of the actuating element 5.

A spring device 6, which has a negative spring constant characteristic, is operatively connected to the second connection 32 of the DEA 3, hereinafter referred to as the NBS (negative bias spring) spring device 6. The negative spring constant characteristic defines a spring force that is dependent on the displacement and decreases with increasing displacement. The negative spring constant characteristic is used in such a way that displacement of the DEA 3 is supported. That is, the spring force difference between the acting spring force during displacement in the non-activated state and the rectified acting spring force during displacement in the activated state is negative. In other words, the displacement of the DEA 3 in the activated state is opposed by a first low spring force and in the non-activated state by a second higher spring force of the spring device 6. Alternatively, the spring device 6 can also be designed and coupled to the DEA 3 in such a way that in the activated state a first higher spring force acts in the direction of the displacement of the DEA 3 and in the non-activated state a second lower spring force acts in the direction of the displacement of the DEA 3.

The coupling points K1, K2 allow a detachable connection to be made both to the second connection 32 of the DEA 3 and to the actuating element 6, so that the linear gear can be used as a reduction gear and as a transmission gear in the actuator 1 and coupled to the DEA 3 and the actuating element 6.

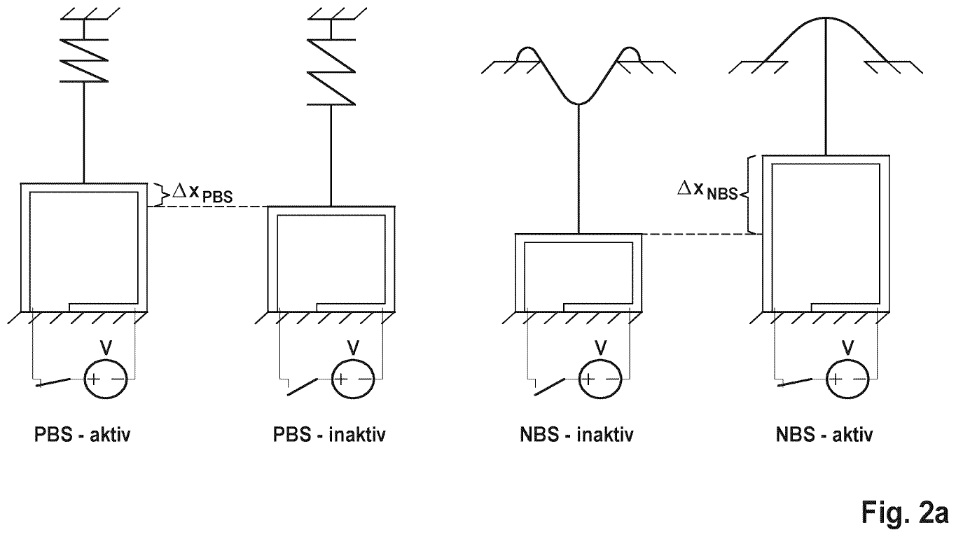

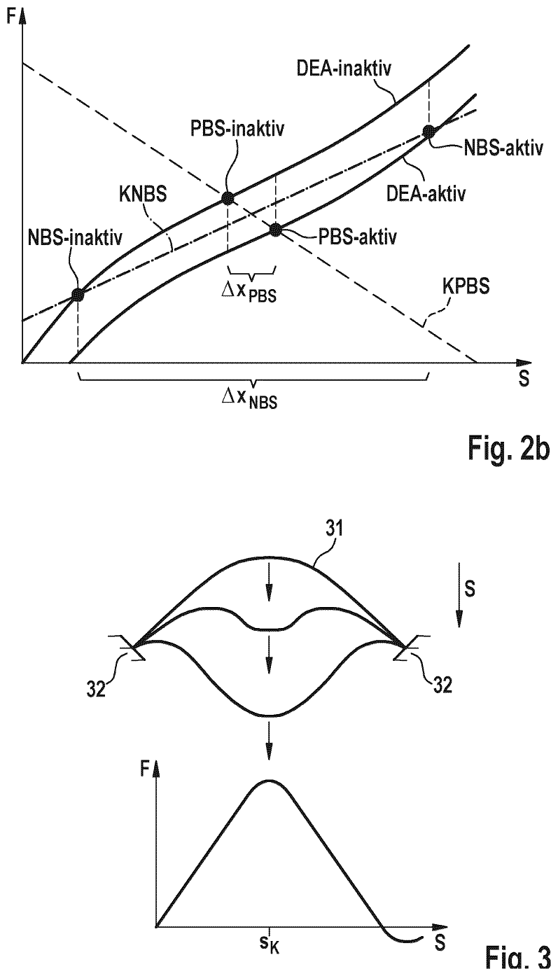

As shown in FIGS. 2a and 2b, by comparing the displacements of a DEA with a spring device with a positive spring constant characteristic (PBS spring device) and an NBS spring device acting in the displacement direction of the DEA 3, the significantly increased displacement can be seen when the DEA 3 is activated in the same way in conjunction with an NBS spring mechanism 6. FIG. 2a show DEAs with a PBS spring mechanism in the activated state PBS-active, with a PBS spring mechanism in the non-activated state PBS-inactive, with an NBS spring mechanism in the non-activated state NBS-inactive and with an NBS spring mechanism in the activated state NBS-active. FIG. 2b shows a force-displacement curve of the DEA in the activated state DEA-active and non-activated state DEA-inactive, as well as the spring characteristic curve KPBS of the PBS spring device and the spring characteristic curve KNBS of the NBS spring device. The points of intersection of the KPWS and KNWS curves with the actuating force/stroke curve of the DEA 3 in the activated and non-activated state correspond to the actuating element positions, ΔxPBS, ΔxNBS the resulting strokes of the DEA 3. It can be seen that the achievable stroke (travel) in the case of the NBS spring device is significantly greater than the achievable displacement in the case of a PBS spring device.

The NBS spring device 6, for example, can be designed with the help of a clamped (preloaded) leaf spring, such as a snap spring, which is used in a displacement range immediately after the tilting point. In principle, such a spring device can be monostable or bistable and have a non-linear characteristic in which there is a local maximum and a local minimum between which the actuating force-stroke characteristic has a negative gradient.

While an increase in the stroke of the actuator can also be achieved simply by means of a (lossless) gear mechanism, the spring device with negative spring constant characteristic simultaneously achieves an increased yield of mechanical work or cyclically repeatable mechanical energy provided by the DEA 3 (quantitatively represented by the areas bounded by the dashed line between the active/inactive DEA curves in FIG. 2b). This improves the efficiency and energy yield of the DEA (in static operation). An actuator that is optimized in terms of efficiency and energy has exactly one actuating force/stroke characteristic that can be adapted to the load (while maintaining the efficiency and performance optimization) using a (downstream and preferably lossless) gear mechanism.

An example of such a snap spring, as shown in FIG. 3, is a buckled beam spring device in which a leaf spring 31 is fixed under compressive prestress in a torsion-resistant manner at two holding points 32. The spring characteristic indicates the curve of the spring force as a function of the deflection s. In this arrangement, a spring force initially increases when the leaf spring is deflected transversely to the direction of arrangement of the holding points 32, but then, when a tipping point is exceeded (at sK) in an NBS deflection range, it exhibits a decreasing spring force with further deflection and can even become negative. By directly mechanically coupling the buckled-beam arrangement with the DEA 3, the DEA 3 can be prestressed in displacement direction A, so that the buckled-beam spring device is in the operating range with the negative spring constant characteristic (NBS displacement range).

In principle, other spring devices with a negative spring constant characteristic can also be used with the actuator described.

The advantage of the negative spring constant characteristic, as shown in FIGS. 2a and 2b, is that a larger stroke can be achieved with the DEA 3. This is particularly useful when using the linear gear 4 in the mounting direction as a reduction gear, since the stroke of the actuating element 6 is reduced by the reduction ratio in relation to a displacement stroke of the DEA 3. In this way, a sufficiently high displacement of the actuating element 6 can also be achieved when using the linear gear 4 as a reduction gear.

The linear gear 4 can be designed in a variety of ways.

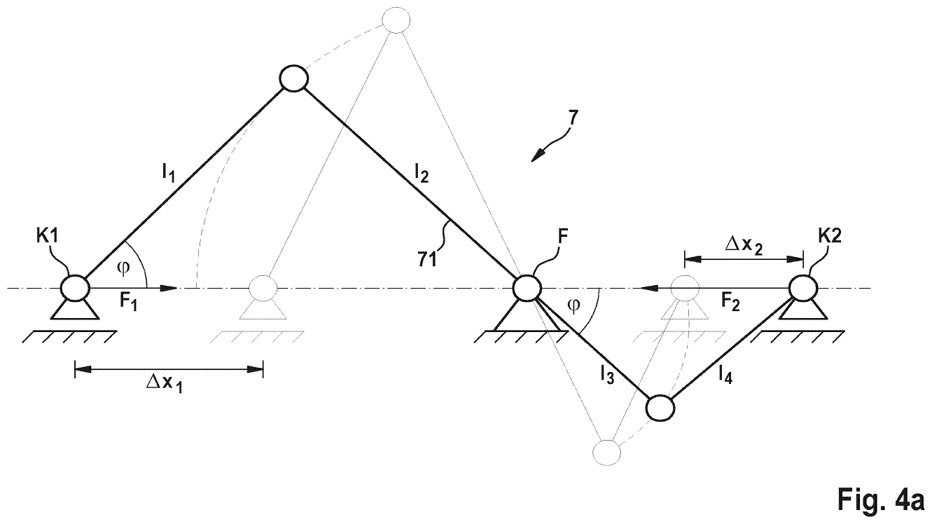

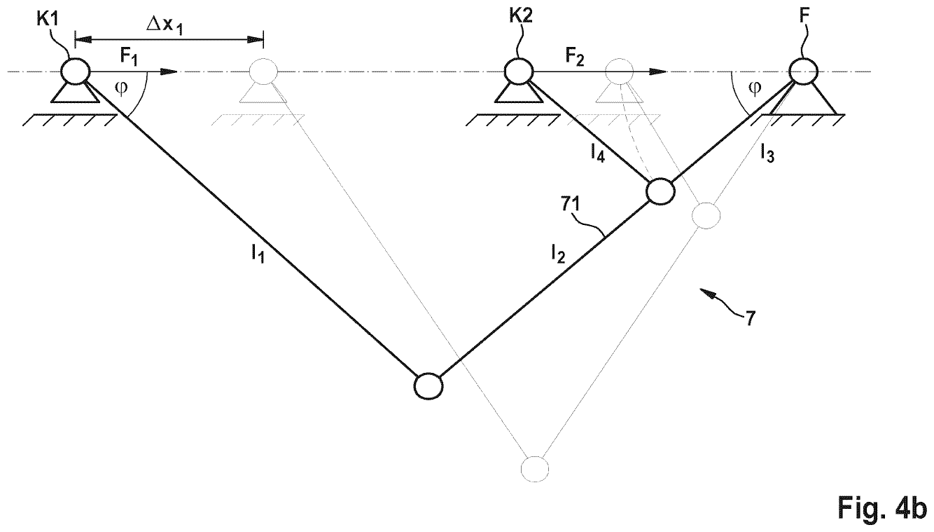

In the present embodiment, the linear gear 4 can be designed as a linkage gear 7, as shown schematically in FIGS. 4a and 4b. The linkage mechanism 7 has three rod elements 71 of the same or different lengths, which are coupled such that they can be pivoted against one another and are arranged such that they can be pivoted at a non-displaceable attachment point F and at two coupling points K1, K2 that are guided in a translational manner, preferably along an identical displacement axis. The arrangement of the rod elements 71 is such that between the two coupling points K1, K2 or between the fastening point F and in each case one of the coupling points K1, K2, two of the rod elements 71 in each case form a triangle with the displacement axis, the interior angle of which changes when the coupling points K1, K2 are displaced. When the coupling points K1, K2 are displaced, the rod elements 71 pivot and are displaced laterally, so that the displacement paths Δx1, Δx2 of the coupling points K1, K2 are linearly dependent. The ratio of the displacements corresponds to a transmission or reduction ratio Δx1/Δx2. The ratio of the forces F1, F2 acting on the coupling points correspond analogously to a transmission or reduction ratio F2/F1.

FIG. 4a shows a linkage mechanism 7 with the attachment point F arranged between the two ends of one of the rod elements, while the ends of the respective rod element 71 are each connected to one end of a further one of the rod elements 71. The further ends of the further rod elements 71 correspond to the coupling points K1, K2 and are guided so as to be movable in translation accordingly. Thus, the attachment point F is located centrally between the two coupling points K1, K2.

A further embodiment of a linkage mechanism is shown in FIG. 4b, wherein a coupling point K2 is arranged between the attachment point F and the corresponding other one of the two coupling points K1. The rod element 71, which is pivotably connected at one end to the attachment point F, is pivotably connected between its two ends to a further rod element 71, the other end of which is connected to the second coupling point K2.

In both linkage mechanisms, the coupling points K1, K2 are mechanically coupled at fixed attachment points, which corresponds to a reduction or an increase.

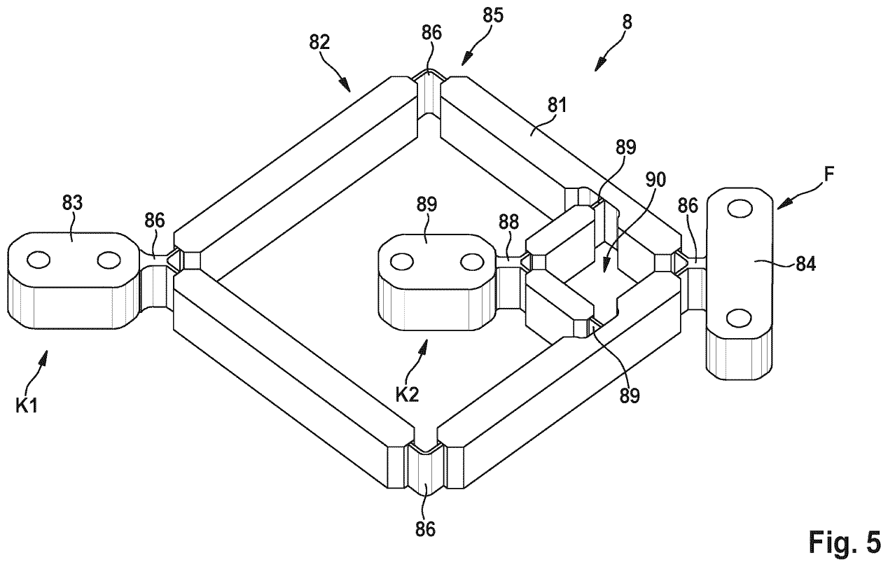

A further possible embodiment of the linear gear, which does not require any translationally leading bearings, is shown in FIG. 5. A quadrangular linkage mechanism 8 can be seen, with four first rod elements 81 which are connected to one another as a flat quadrangle to form a first linkage arrangement 82, so that the ends of the rod elements 81 form comers at which the rod elements 81 can be pivoted in relation to one another in a pivoting direction which lies in the surface direction of the quadrangle. The corners 85 of the first linkage arrangement 82 are provided with flexible connecting elements 86, for example made of a flexible plastic (e.g. thermoplastic polyurethane) or the like, which have a smaller cross-section than the rod elements 81 and are in the form of strips, in order to allow pivoting preferably only in the surface direction of the first linkage arrangement 82. Alternatively, corresponding joints can also be provided.

A first corner of the first linkage arrangement 82 can be provided with a first holding arrangement 83, which forms the first coupling point K1. A second corner 85 lying opposite thereto, which forms the fastening point F, can be provided with a fastening device 84 for fastening the quadrilateral linkage mechanism 8 in a stationary manner, i.e. for example for attaching it to the housing 2.

The first linkage arrangement 82 can be coupled to a second linkage arrangement 90 having two second rod elements 87 that are pivotally connected to each other via a third corner 88 and that are attached to two first rod elements 81 of the first linkage arrangement 82 and are attached at a distance from the second corner 85 such that they can pivot via further flexible connecting elements 89, so that when the first linkage arrangement 82 is adjusted, the internal angles of the second linkage arrangement 90 change accordingly. The third corner can be connected to a second holding arrangement 89, which represents a second coupling point K2.

The second rod elements 87 can be shorter than the first rod elements 81, so that a linear mechanism is formed that realizes a reduction between the first and second coupling points K1, K2. The first rod elements 81 and the second rod elements 87 can each be provided with a length such that the four-bar linkage mechanism is designed symmetrically with respect to the axis running through the attachment point F and the coupling points K1, K2.

The attachment point F, the first coupling point K1 and the second coupling point K2 lie on one axis and in an actuator 1, this axis can run parallel to the direction of displacement A of the actuating movement of the DEA 3 and the direction of adjustment S of the longitudinally guided actuating element 6.

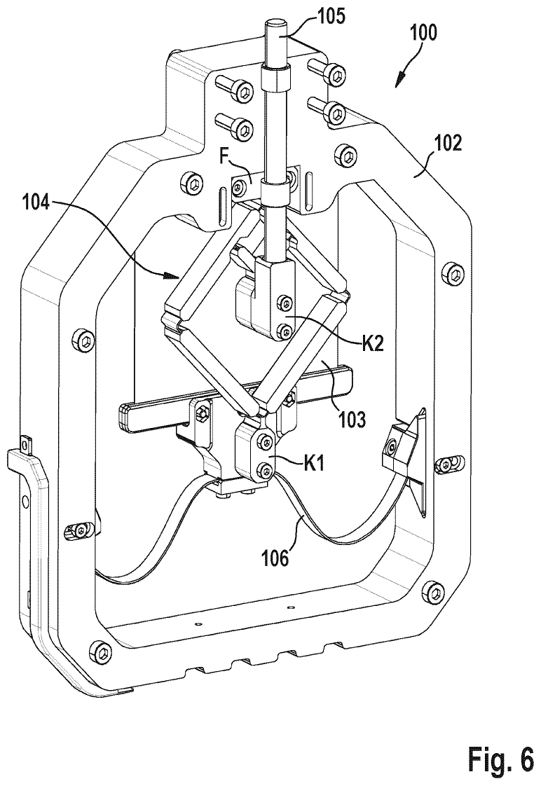

FIG. 6 shows a schematic perspective view of a possible embodiment of an actuator 101, which essentially corresponds to the mode of operation of the generally described actuator 1 of FIG. 1 and has a buckled beam mechanism of FIG. 3 and a linear gear 104 of FIG. 5 as a spring device 106.

The housing 102 and the actuating element 105 guided on the frame of the housing 102 can be seen. Furthermore, the DEA 103 is attached to the housing 102 by its first connection. A second connection of the DEA 103 is detachably connected, for example, by means of a screw connection, plug connection or another type of form-fitting and/or frictional detachable connection, to a coupling point K2 of a linear gear 104. Furthermore, the actuating element 105 is detachably connected, here exemplarily via a screw connection, to one of the coupling points K1 of the linear gear 104.

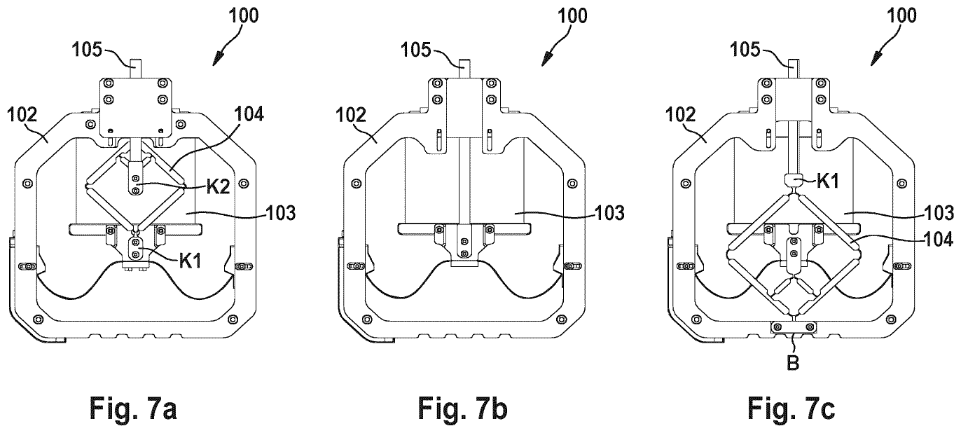

FIGS. 7a and 7c show top views of various configurations of the actuator of FIG. 6. In the representations of FIGS. 7a and 7c, the linear gear is arranged between the actuating element 105 and the DEA 103 in different mounting positions. Depending on the mounting position of the linear gear 104, a transmission or reduction can be realized. The fastening device of the linear gear can also be arranged in a releasable manner, in particular by means of a screw connection, on different sides of the frame of the housing 102 for the various configurations.

As shown in FIG. 7b, the terminal point of the actuating element 105 and the second terminal of the DEA 103 can be connected directly to one another, without a linear gear, in order to achieve a direct drive of the actuating element 105 by the DEA 103.

In the example shown, the NBS spring device 106 is designed as a buckled beam device, in which a prestressed leaf spring is clamped in the frame of the housing 102. This has a spring plate in the form of a leaf spring, which is firmly clamped under prestress between two opposite legs of a housing frame surrounding the actuator. When the DEA 103 is displaced in the non-activated state and in the activated state with maximum actuation, the spring plate is deformed in such a way that a W is formed, i.e. so that the actuating positions of the activated state and of the non-activated state of the DEA 103 lie in the region of a negative spring constant characteristic of the spring device 106 with respect to an increasing displacement of the DEA 103.

Instead of the buckled beam device, the spring device 106 can also be designed in combination with the linkage mechanism 104, as shown, for example, in connection with FIGS. 4a, 4b and 5, by exerting a spring force in the direction of a decreasing angle on two neighboring or also opposing rod elements 81 of the linkage mechanism 104 are biased by a preloaded tension spring or compression spring, such as a spiral spring, as a spring element with a positive spring constant characteristic with a spring force in the direction of a decreasing angle between the rod elements 81 or between the axis and one of the rod elements 81. Furthermore, spring elements can be attached between opposing joints. This results in a spring characteristic of the entire arrangement, which in a specific working range (stroke range) has a spring constant that varies depending on the stroke and has a negative spring constant with respect to the increasing displacement of the DEA 103 when it is activated.

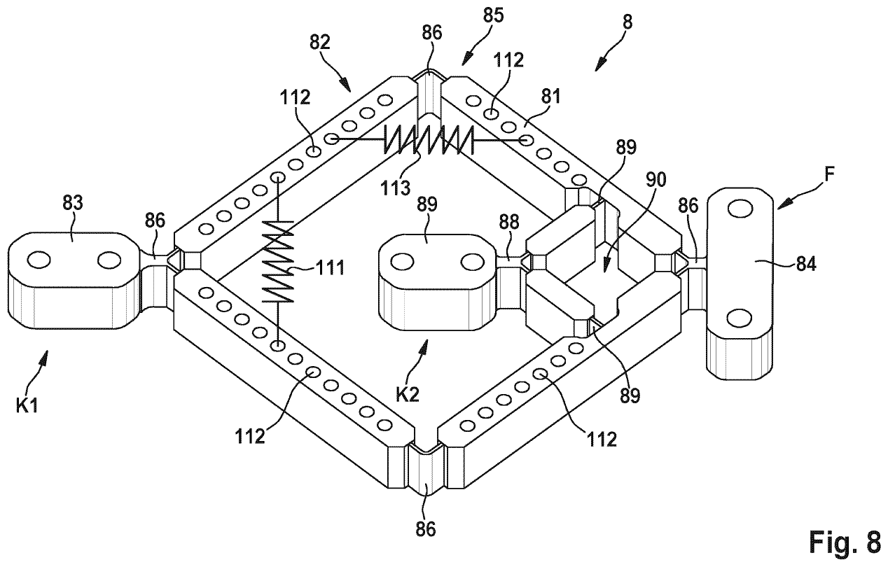

FIG. 8 shows an example of such an arrangement. The tension spring 111, as a spring element with a positive spring constant characteristic, is arranged between the rod elements 81 of the linkage mechanism 8, which are adjacent to the first coupling point K1, so that the tension spring 111 exerts a force in the direction of a decreasing angle between the respective rod elements 81. The tension spring is attached at a respective attachment point 112 between the ends of the corresponding rod elements 81. If the angle between the respective rod elements 81 exceeds a critical angle, which depends on the distance between the attachment points 112 and the spring constant of the tension spring 111, the entire arrangement exhibits a negative spring constant characteristic, i.e. h. with respect to the coupling points K1, K2, the counterforce decreases with increasing stroke of the DEA 103 (increasing angle enclosed by the triangle consisting of the spring element 111 and the rod elements 81).

Alternatively, the spring element with the positive spring constant characteristic can also be connected at one end to a fixed (fixed to the housing) mounting point. Another end of the spring element can then act on one of the rod elements 81 in such a way that when the linear gear is adjusted, the angle between the direction of the spring force and the course of the rod element 81 changes.

In principle, there are many possibilities for arranging one or more spring elements with a positive spring constant characteristic within the linkage, as long as they act in the direction of a reducing angle between a rod element at each of the coupling points K1, K2 and the translational direction of movement of the respective coupling point K1, K2. In this case, the point of application of the spring element or elements can be arranged directly on the rod element connected to the respective coupling point K1, K2, or can act indirectly on it, so that the spring element exerts a force in the direction of a decreasing angle between the rod element at the respective coupling point and the axis of the direction of movement of the respective coupling point.

In the above four-bar linkage mechanism, a further spring element 113 can alternatively or additionally be designed as a compression spring parallel to the axis of the coupling points K1, K2, which is arranged between two of the rod elements 81 and also has the effect of reducing the angle between the respective rod element at the coupling points and the axis of translational movement of the coupling points.

A plurality of attachment points 112 may be provided on the respective rod elements 81, to which the tension spring 111 is selectively attached to influence the critical angle and adjust the characteristic of the actuator. The attachment points 112 may be provided, for example, as openings or protruding pins in/on the rod elements 81. By form-fitting attachment of the ends of the tension spring 111 to a selected attachment point on the bar elements 81, the negative spring constant characteristic is selected in order to realize the increased adjustment path. The further apart the selected attachment points 112 are spaced, between which the tension spring 111 is inserted, the greater the spring force acting in between, so that the achievable force difference between the positions when the spring device is activated and when it is not activated is increased.

Alternative or additional spring elements can be arranged to adjust the spring constant characteristic of the spring device.

The linear gear is exemplarily represented herein as a square linkage. A linear gear constructed in such a way can be constructed in a simple manner in one piece, whereby the rod elements can be designed by corresponding bending joints. These can be formed in a simple manner by providing a smaller thickness or by using an elastic material. In this way, the entire linear gear can be designed in one piece. To realize a spring device with such a linear gear, a spring element, e.g. in the form of a spiral spring or the like, can be arranged between two adjacent rod elements.

1. A translatory actuator comprising:
a dielectric elastomer actuator (DEA) configured to be altered from a non-activated state into an activated state by applying an electrical voltage so that a change in length occurs in at least one displacement direction (A) between two terminals;
an actuating element for providing an actuating stroke and/or an actuating force in a translatory actuating direction (S);
a linear gear connecting the DEA to the actuating element with a gear reduction or a gear ratio;
a spring device that is mechanically coupled to the DEA and/or to the linear gear and/or comprises the linear gear the spring device having an at least partially negative spring constant characteristic, so that when the DEA is activated, its displacement in the displacement direction (A) is supported with a greater force or its displacement is counteracted by a smaller force than in the non-activated state.

2. The actuator according to claim 1, wherein a first connection of the DEA is fixed in a stationary manner with respect to the actuator.

3. The actuator according to claim 1, wherein the linear gear is bidirectional and has a first coupling point and a second coupling point, wherein the first coupling point can be detachably connected to a second terminal of the DEA and the second coupling point can be detachably connected to the actuating element and the second coupling point can be detachably connected to a second terminal of the DEA and the first coupling point can be detachably connected to the actuating element.

4. The actuator according to claim 3, wherein the spring device has a buckled beam mechanism which is mechanically coupled to the DEA in such a way that the displacements both in the non-activated state and in the activated state are in a range of negative spring constant characteristics in which a spring constant of the spring device is negative with respect to a displacement of the DEA.

5. The actuator according to claim 3, wherein the linear transmission has a linkage transmission in which at least three rod elements are pivotally connected to one another at coupling points, so that during an actuating movement of the actuator all the angles between the rod elements change, two of the coupling points being displaceably mounted.

6. The actuator according to claim 5, wherein the linear gear comprises a first linkage arrangement with first rod elements arranged to form a flat square, which are connected to one another at corners of the square and are pivotable in the surface direction of the square, wherein a second linkage arrangement is provided with two second rod elements forming a further flat square of different size with two of the first rod elements of the first linkage arrangement, which has corners at which the rod elements can be pivoted relative to one another, the rod elements being dimensioned such that three comers of the linkage arrangements lie in a row and form an attachment point and the first and second coupling points.

7. The actuator according to claim 6, wherein the attachment point is arranged on a housing of the actuator in a detachable manner.

8. The actuator according to claim 5, wherein at least one spring element with a predetermined positive spring constant is arranged on one of the rod elements and/or between two rod elements coupled to one another in a pivotable manner in such a way that a moment in the direction of a decreasing angle at the coupling points with respect to the direction of displacement, the angular range of possible angles at the coupling points for a displacement of the DEA in the non-activated state and in the activated state with maximum actuation being above a limit angle, from which the negative spring constant characteristic is present.

9. The actuator according to claim 5, wherein at least one spring element with predetermined positive spring constant is arranged with one end on one of the rod elements, so that a moment is effected on the relevant rod element in the direction of an increasing angle between the direction of the acting spring force and the longitudinal direction of a section of the relevant bar element to the corresponding coupling point, the angular range of possible angles between the bar elements and the direction of the spring force for a displacement of the DEA in the non-activated state and in the activated state at maximum drive being below a limit angle below which the negative spring constant characteristic is present.

10. The actuator according to claim 8, wherein the at least one spring element is removably attached to the respective rod element(s), wherein in particular a plurality of attachment points are arranged on the respective rod elements for removably attaching the spring element at different distances from a corner between the respective rod elements.
